(19) United States
(12) Patent Application Publication
(10) Pub. No.: US 2003/0119540 A1
(43) Pub. Date: Jun. 26, 2003

(54) Contact list-based group call

(76) Inventor: James Earl Mathis, Barrington, IL (US)

Correspondence Address: MOTOROLA INC, 600 NORTH US HIGHWAY 45, LIBERTYVILLE, IL, 60048-5343, US

(21) Appl. No.: 10/036,924

(22) Filed: Dec. 21, 2001

(51) Int. Cl. H04Q 7/20

(52) U.S. Cl. 455/518; 455/519; 455/515

(57) ABSTRACT

The present invention is a network (110) and method for conducting a group call among communication devices (102, 104, 106, 108) based on presence information of the communication devices. The presence information (FIGS. 2 and 3) is displayed (410) at a particular communication device (106) that has access to a contact list (126), which identifies members of the group call. The presence information includes a presence status for each of the members of the group call. Next, the network detects (430) an activation of the group call at the particular communication device. In response to detecting the activation, the network establishes (440) the group call among the communication devices based on the contact list of the particular communication device. To establish the group call, a communication link is established with each of the members of the group call.

### FIELD OF THE INVENTION

The present invention relates generally to the field of wireless communication systems and, more particularly, to systems and methods for providing group call services to a plurality of client devices of a wireless communication system.

### BACKGROUND OF THE INVENTION

Dispatch communication is an effective means of coordinating the activities of members of a work, task, interest, collocation, or similar affinity group. In a group call dispatch service, talk groups are defined for such affinity groups and specific radio units are assigned to the talk groups. Depending on their capabilities, some radio units may be assigned to multiple talk groups. The assignment of radio units to talk groups can be fixed or dynamically varying based on some property of the user or radio. When one user initiates communications, the communication is efficiently delivered to all members of the talk group. For a typical voice communication, one user will indicate their intent to speak (such as by pressing the “push to talk” button or a similar mechanism), begin speaking, and have their voice played out at the plurality of other radio units assigned to the talk group. In trunking style systems, a control function will supervise radio channel and resource assignment, and control user access to efficiently share the communication medium. In conventional style systems, sharing control is a user responsibility and users cooperate in access to the radio channel; talk groups are effectively determined dynamically based on radio channel assignments.

In both types of systems, a user does not know before initiating communications whether any other users are available to receive the communication and whether specific other users are available to receive the communication. The user can use such knowledge in various ways including, but not limited to, deciding to temporarily delay initiating a group call, and deciding to initiate communication to an alternate talk group or groups. Distributing presence information to users can solve this lack of knowledge before initiating the group call.

### SUMMARY OF THE INVENTION

The present invention is a network and method for conducting a group call among communication devices based on presence information of the communication devices. The presence information is displayed at a particular communication device that has access to a contact list, which identifies members of the group call. The presence information includes a presence status for each of the members of the group call. Next, the network detects an activation of the group call at the particular communication device. In response to detecting the activation, the network establishes the group call among the communication devices based on the contact list of the particular communication device. To establish the group call, a communication link is established with each of the members of the group call.

### BRIEF DESCRIPTION OF THE DRAWINGS

FIG. 1 is a block diagram representing a wireless communication system that may be adapted to operate in accordance with the preferred embodiment of the present invention.

FIG. 2 represents of a typical display of a particular client device, such as one of the client devices shown in FIG. 1, in which all members of a talk group are available.

FIG. 3 represents a typical display of a particular client device, such as one of the client devices shown in FIG. 1, in which one member of a talk group is not available.

FIG. 4 is a flow diagram representing a method for using presence information in invoking a group call, such as in a system shown in FIG. 1.

### DETAILED DESCRIPTION OF THE PREFERRED EMBODIMENT

The present invention uses presence information to improve the functioning of dispatch group call and provide the mechanisms for enhancements to dispatch group call functions. In the preferred embodiment, each radio unit maintains a contact list that contains the current presence status of talk groups and of individual users. This contact list is kept current using information sent from a central server or obtained from an equivalent distributed algorithm. This contact information is displayed or otherwise made available to each radio's user.

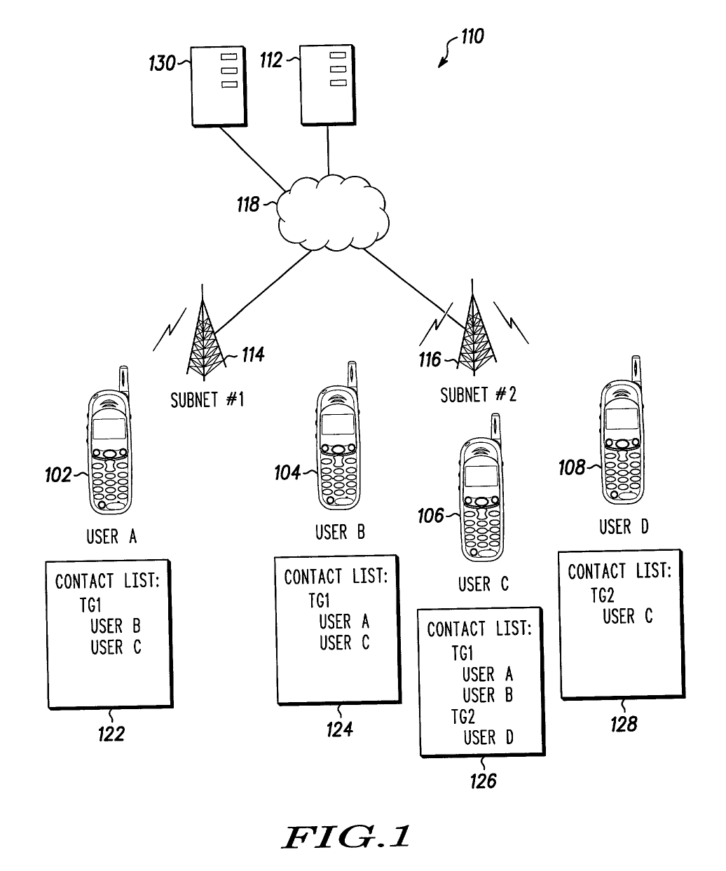

Referring to FIG. 1, the preferred embodiment includes a plurality of client devices 102, 104, 106, 108 associated with a data communication network 110. For purposes of illustration, the communication network 110 includes a presence status server 112, a group call processing server 130, two radio subnetworks (namely subnetwork #1 114 and subnetwork #2 116), and wireless connectivity 118 between the client devices 102, 104, 106, 108 and the server. It is to be understood that the present invention may also be applied to a different configuration of client devices and a communication network, such as a plurality of servers or connection to a wired network. The client devices 102, 104, 106, 108 and the servers 112 and 130 each include a processor for general operation of the server and a memory for storage of applications and data.

For the example represented by the preferred embodiment, the four client devices 102, 104, 106, 108 are labeled User A, User B, User C, and User D respectively and the two talk groups are labeled TG1 and TG2. User A's client device 102 is on a separate radio subnetwork 114 from the subnetwork 116 of the other client devices 104, 106, 108. TG1 is comprised of User A, User B and User C; and TG2 is comprised of User C and User D. In practical situations, there will be many more radios, many more talk groups, many subnetworks and larger contact lists.

Each client device 102, 104, 106, 108 includes a contact list 122, 124, 126, 128 (a.k.a. a buddy list) that is capable of identifying one or more of the talk groups configured for the communication network 110 and one or more of the other client devices connected to the communication network 110. Each contact list 122, 124, 126, 128 may identify none of the client devices 102, 104, 106, 108 or at least one of the client devices connected to the communication network 110. A particular client device 102, 104, 106, 108 would include a contact list 122, 124, 126, 128 that identifies other client devices, but the contact list would not identify the particular client device itself. In FIG. 1, the contact lists 122, 124, 126, 128 are shown beneath the client devices 102, 104, 106, 108. However, for the present invention, each contact list 122, 124, 126, 128 is stored in a memory of the respective client device 102, 104, 106, 108, or collectively stored in a memory located in the communication network 110. For the preferred embodiment, the contact lists 122, 124, 126, 128 are stored in a memory of the server 112. The contact lists 122, 124, 126, 128 may also identify a group or collection of users in addition to, or instead of, individual users.

For the preferred embodiment, users of the client devices 102, 104, 106, 108 utilize client software stored by the client devices that offer the ability to track and display the presence status of groups and other users connected to the communication network 110. Each entry of the contact lists 122, 124, 126, 128 corresponds to a configured talk group or another user or, more particularly, another client device 102, 104, 106, 108 connected to the communication network 110. Information about the user and/or client device 102, 104, 106, 108 may be associated with each entry including, but not limited to, presence information such as online status (e.g., available to communicate), off-line status (e.g., unavailable), location attribute & capabilities, device attributes & capabilities, communication network attributes & capabilities (e.g., network resource availability). Information about talk groups may be associated with each entry including, but not limited to, presence information such as online status (e.g., group members available to communicate), off-line status (e.g., no group members available), location attributes & capabilities, device and service attributes & capabilities, communication network attributes & capabilities (e.g., network resource availability). Presence information is generally dynamic in nature, changing over time based on various factors and conditions. Thus, updates to the presence information must be transmitted to relevant client devices 102, 104, 106, 108 to update their respective contact lists 122, 124, 126, 128. A variety of mechanisms exist to distribute presence information to a plurality of client devices. In the preferred embodiment, the server 112 uses an efficient multicast-based distribution mechanism, similar to the one described in U.S. patent application Ser. No. ______, filed Oct. 29, 2001, to James E. Mathis titled “Multicast Distribution Of Presence Information For An Instant Messaging System” (Attorney Docket No. PF02248NA).

Each talk groups TG1, TG2 can be configured to be available for presence purposes based on the availability of specific critical users, availability of specific hardware resources such as radio sites, or other functions of the presence attributes of the plurality of talk group member users or of such user's client device 102, 104, 106, 108. This mechanism of determining talk group presence provides results similar to the results of various well-known call-start mechanisms common in private radio dispatch systems. When a talk group is considered on-line, the call-start criteria would be satisfied when a group call is placed. In the preferred embodiment, the list of client devices assigned to each talk group and any availability restrictions is stored in the server 112. In an alternate embodiment, the composition of each talk group (i.e., list of assigned client devices) and any availability restrictions are stored in client devices 102, 104, 106, 108 and client devices 102, 104, 106, 108 make a determination of the presence status using information from the plurality of client devices and from the communication network 110.

The group call processing server 130 performs the necessary functions to setup and tear-down the group call service, including but not limited to network resource allocation, radio channel allocation and translations of user identification to device numbers or addresses. The group call processing server 130 is configured with the list of client devices assigned to each talk group and with any call-start restrictions (including but not limited to critical user or critical site). The group call processing server 130 communicates with affected client devices 102, 104, 106, 108 and communication resources (such as network 110, and subnetworks 114 and 116) to perform its function, and communicates with presence server 112 to update the presence availability status of talk groups. In the preferred embodiment, presence server 112 then distributes presence availability status updates to client devices 102, 104, 106, 108. Alternate embodiments of the group call processing function are possible, with the function implemented within communication network 110 or distributed amongst a plurality of client devices 102, 104, 106, 108.

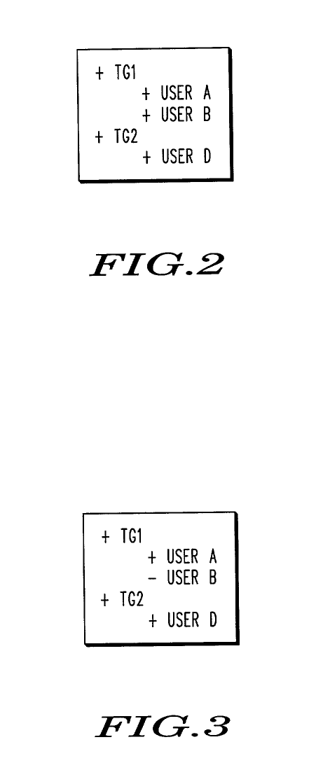

Referring to FIGS. 2 and 3, in the preferred embodiment, the user device is enhanced to display the contact list along with a visual display of each entry's presence status. In this example, for the client device 106 of User C, the TG1 is shown as on-line and furthermore, User A and User B status are displayed. For the preferred embodiment, the presence status of User A and User B are visually coupled with the display of TG1 so that the user can easily determine that the current composition of TG1 is User A and User B. This visual coupling is indicated by placing the display of User A and User B status under the display of TG1 and indented to the right.

If the visual display of the user device changes from the information of FIG. 2 to the information of FIG. 3, then the status of User B has changed to unavailable. For the preferred embodiment of FIGS. 2 and 3, the “+” symbol is used to denote a talk group or individual user that is available for communications; the “−” symbol is used to denote a talk group or individual user that is currently unavailable for communication. Alternate embodiments are possible that use other symbols or indicators to indicate the presence status value. A talk group or individual user may be unavailable for communications for a variety of reasons, including but not limited to, lack of network resources, lack of subnetwork resources, lack of radio channel resources, client device busy with other operations, out-of-communication range, and user-specified do-not-disturb. In one alternate embodiment, the indicators for available or unavailable (“+” and “−” in the preferred embodiment) may be replaced with indicators that indicate device capabilities if available (including but not limited to audio, images, video) and indicate failure reasons if unavailable (including but not limited to user busy, no resources).

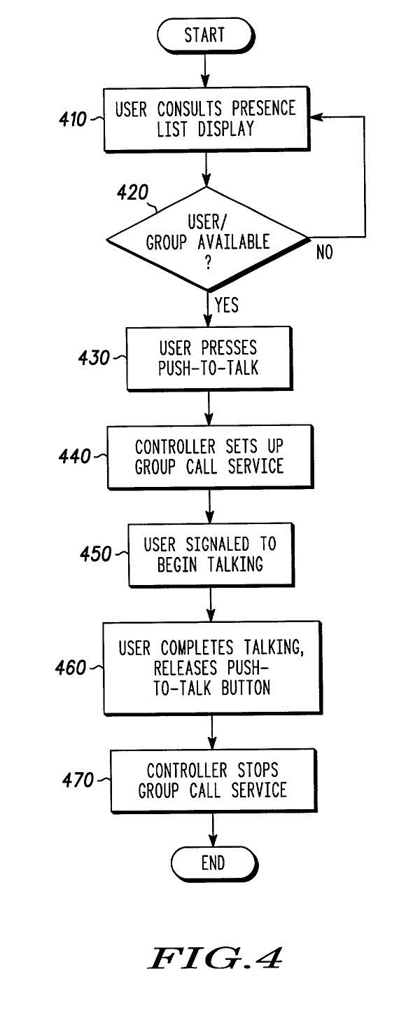

Referring to FIG. 4, there is shown a sequence of actions for placing a dispatch group call for the preferred embodiment. At step 410, a client device operated by a user consults the contact list display for the desired talk group or critical user. For the preferred embodiment, the user's client device is capable of visually displaying the presence status of a plurality of possible talk groups and users. In the alternative, other means may be used to communicate the presence status to the user including, but not limited to, simple indicator lights, audio indicators or tones, and vibrations. For the preferred embodiment, at step 420, the user monitors the presence status until the desired talk group or individual is available. At step 430, the user presses the push-to-talk button or otherwise indicates intent to invoke the dispatch group call service. At step 440, the control function processes the service request and performs the necessary actions including, but not limited to, assigning resources and allocating radio channels, to setup the group call service. At step 450, the availability of the service is indicated to the user and the user begins to talk. In step 460, the user concludes talking and indicates the completion of the service. At step 470, the control function releases assigned resources and performs other functions at the completion of the service.

A variety of different embodiments of the function of providing a group call service, as defined in steps 430 through 470, are possible without departing from the spirit and scope of the present invention as defined by the appended claims. In particular, the group call functions defined in steps 430 through 470 could be performed in a trunking system manner where radio units are dynamically assigned to radio frequencies or performed in a conventional system manner where radio units have fixed radio frequency assignments. In addition, the present invention may be adapted to operate in accordance with other wireless systems, such as a cellular, paging and wireless local area networks, as well as other wireless protocols, such as Analog, CDMA, GSM, TDMA, UMTS, FLEX, REFLEX, Bluetooth, Wi-Fi (i.e., IEEE 802.11), HomeRF, and infrared communication protocols.

While the preferred embodiment of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method for conducting a group call among communication devices based on presence information of the communication devices, the method comprising the steps of:
displaying presence information at a particular communication device, the particular communication device having access to a contact list that identifies members of the group call, the presence information including a presence status for each of the members of the group call;
detecting activation of the group call at the particular communication device; and
establishing the group call among the communication devices based on the contact list of the particular communication device, wherein a communication link is established with each of the members of the group call.

2. The method of claim 1, further comprising the step of creating the contact list associated with the particular communication device before the step of displaying the presence information at the particular communication device, wherein the contact list identifies the members of the group call.

3. The method of claim 1, wherein the particular communication device accesses the contact list from a database maintained by the particular communication device.

4. The method of claim 1, wherein the particular communication device accesses the contact list from a database maintained by a network infrastructure in wireless communication with the particular communication device.

5. The method of claim 1, wherein the step of detecting activation of the group call includes the step of detecting an activation of a push-to-talk button at the particular communication device.

6. The method of claim 5, wherein the step of establishing the group call occurs while the push-to-talk button is still activated.

7. The method of claim 1, further comprising the step of indicating that the group call has been established.

8. The method of claim 7, wherein the step of indicating that the group call has been established includes the step of signaling to the particular communication device to provide a voice message.

9. The method of claim 1, further comprising the step of detecting a voice message at the particular communication device that is directed to the other members of the group call.

10. The method of claim 1, further comprising the step of detecting a de-activation of the group call at the particular communication device.

11. The method of claim 10, wherein the step of detecting a de-activation of the group call includes the step of detecting a release of a push-to-talk button at the particular communication device.

12. The method of claim 1, further comprising the step of terminating the group call among the communication devices.

13. The method of claim 12, wherein the step of terminating the group call includes the step of disconnecting the communication link with each of the members of the group call.

14. The method of claim 1, wherein the particular communication device includes an instant messaging application and the contact list is accessed by the instant messaging application.
